(19) United States
(12) Patent Application Publication
(10) Pub. No.: US 2019/0286606 A1
(43) Pub. Date: Sep. 19, 2019

(54) NETWORK-ON-CHIP AND COMPUTER SYSTEM INCLUDING THE SAME

(71) Applicant: ELECTRONICS AND TELECOMMUNICATIONS RESEARCH INSTITUTE

(72) Inventors: Kyuseung HAN, Daejeon (KR); Hyeong Uk JANG, Daejeon (KR); Sukho LEE, Daejeon (KR); Jae-Jin LEE, Daejeon (KR)

(21) Appl. No.: 16/265,598

(22) Filed: Feb. 1, 2019

(30) Foreign Application Priority Data
Mar. 13, 2018 (KR) 10-2018-0029414

(51) Int. Cl. G06F 13/42

(52) U.S. Cl. CPC G06F 13/4234; G06F 2213/16; G06F 2213/3808; G06F 2213/0042

(57) ABSTRACT

Provided is a computing device. The computing device includes electronic circuits, and a network-on-chip configured to provide a communication channel between the electronic circuits. One of the electronic circuits is a processor. The network-on-chip includes a memory management unit for supporting a use of a virtual memory address of the processor.

### CROSS-REFERENCE TO RELATED APPLICATIONS

This non-provisional patent application claims priority under 35 § 119 of Korean Patent Application No. 10-2018-0029414, filed on Mar. 13, 2018, the entire contents of which are hereby incorporated by reference.

### BACKGROUND

The present disclosure herein relates to a network-on-a-chip and a computing device including the same.

Electronic devices such as computers, smart phones, and smart pads may be implemented with a combination of various electronic circuits hardware modules). Various electronic circuits may perform various functions through mutual interaction. A network-on-chip has been proposed as a method for providing a channel with improved scalability between electronic circuits. The network-on-chip uses a scheme that assigns unique addresses to attached circuits and routes communications between attached circuits based on the unique addresses.

As the number of hardware modules embedded in a single chip system System on Chip (SoC)) increases, the network-on-chip may address limitations that may arise in bus-on-chip connections (for example, increase in the density and complexity of on-chip interconnects). In a single chip system using a network-on-chip, the processor may communicate with other hardware modules through a dedicated network interface (NI) on the network-on-chip.

### SUMMARY

The present disclosure is to provide a network-on-chip of type including a memory management unit.

An embodiment of the inventive concept provides a computing device including: electronic circuits; and a network-on-chip configured to provide a communication channel between the electronic circuits, wherein one of the electronic circuits is a processor, wherein the network-on-chip includes a memory management unit for supporting a use of a virtual memory address of the processor.

In an embodiment of the inventive concept, a network-on-chip for providing a communication channel between a processor and electronic circuits. The network-on-chip includes: network interfaces corresponding to the processor and the electronic circuits, respectively, and configured to convert a type of transactions received from each of the processor and the electronic circuits; and at least one switch connected to the network interfaces to control transmission of the transactions between the network interfaces, wherein among the network interfaces, a network interface corresponding to the processor includes a memory management unit.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram illustrating a computing device according to an embodiment of the present disclosure;

FIG. 2 is a block diagram illustrating an example configuration of computing device of FIG. 1;

FIG. 3 is a block diagram illustrating an example configuration of computing device of FIG. 1;

FIG. 4 is a block diagram illustrating, an example configuration of computing device of FIG. 1; and

FIG. 5 is a block diagram rating an example configuration of computing device of FIG. 1.

### DETAILED DESCRIPTION

Below, in order for the inventive concept to be easily implemented by those skilled in the art, some embodiments will be described in detail and with reference to the accompanying drawings.

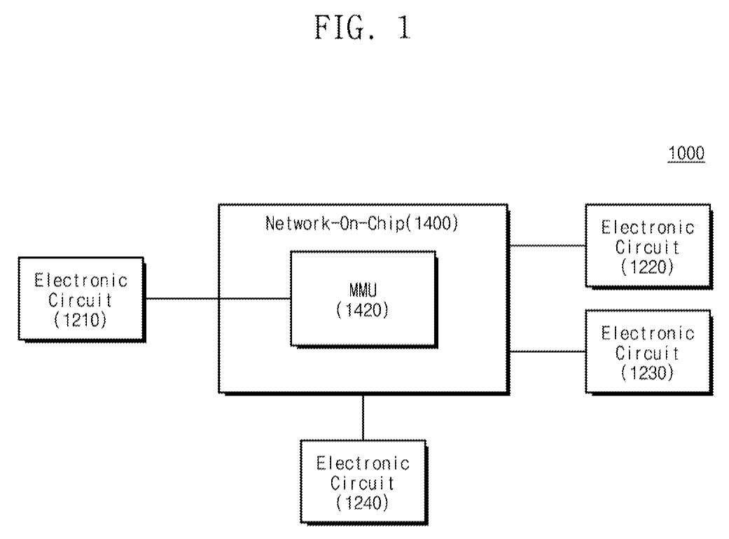

FIG. 1 is a block diagram illustrating a computing device according to an embodiment of the present disclosure.

The computing device 1000 may include electronic circuits 1210, 1220, 1230, and 1240, and a network-on-chip (NOC) 1400. In FIG. 1, the computing device 1000 is illustrated as a single chip system (e.g., a system on chip) that implements a system for performing various operations using one chip, but the present disclosure is not limited thereto.

For convenience of explanation, the computing device 1000 is assumed to include four electronic circuits 1210, 1220, 1230, and 1240, but the computing device 1000 may include various numbers of electronic circuits.

The electronic circuits 1210, 1220, 1230, and 1240 may be the main circuits that constitute the computing device 1000. Each of the electronic circuits 1210, 1220, 1230, 1240 may include peripheral devices that are designed and manufactured to perform a specific function. The electronic circuits 1210, 1220, 1230, and 1240 may perform various functions that are supported by the computing device 1000 through interaction with each other.

For example, each of the electronic circuits 1210, 1220, 1230, and 1240 may include at least one of various circuits such as a central processing unit or application processor, main memory, cache memory, video, codec, audio codec, graphics processor, storage device, Universal Asynchronous Receiver Transmitter (UART) Interface, a random access memory (RAM), a read only memory (ROM), a serial programming interface (SPI), a universal serial bus (USB) interface, a power control circuit, a sensor, and the like. According to one embodiment of the present disclosure, each of the electronic circuits 1210, 1220, 1230, and 1240 may be implemented in the form of an intellectual property (IP) block on a single package or on a single chip.

The NOC 1400 may provide communication channels between the electronic circuits 1210, 1220, 1230, and 1240. The NOC 1400 may include network interfaces corresponding to the electronic circuits 1210, 1220, 1230, and 1240, respectively. For example, the electronic circuits 1210, 1220, 1230, and 1240 may communicate with each other through network interfaces corresponding to the electronic circuits 1210, 1220, 1230, and 1240, respectively.

Hereinafter, the electronic circuit 1210 may be a processor. For example, the electronic circuit 1210 may be a central processing unit (CPU), a microprocessor, or a microcontroller unit (MCU). The electronic circuit 1210 may be a processor without a built-in memory management unit.

The memory management unit may be a hardware module for managing the access of the processor to the memory, and may support the virtual memory use of the processor. For example, the memory management unit may convert a virtual memory address received from a processor into a real memory address. The memory management unit may support the multiprocessing operation of the processor.

According to one embodiment of the present disclosure, when the electronic circuit 1210 is a small or lightweight processor, the electronic circuit 1210 may not include a memory management unit.

The NOC 1400 includes the memory management unit 1420 so that the function of the memory management unit 1420 may be supported by the electronic circuit 1210 in which the memory management unit is not embedded. As the computing device 1000 includes a memory management unit 1420 in the NOC 1400, at the design or fabrication stage of the electronic circuit 1210, the computing device 1000 may provide the functionality of the memory management unit 1420 to the electronic circuitry 1210 without changing the structure of the electronic circuit 1210. For example, when the electronic circuit 1220 is a Static Random Access Memory (SRAM), the memory management unit 1420 embedded in the NOC 1400 enables the electronic circuit 1210 to access the electronic circuit 1220 using a virtual memory address, thereby maximizing memory efficiency.

According to embodiment of the present disclosure, the computing device 1000 may use the memory management unit 1420 regardless of the type of electronic circuit 1210. Accordingly, the electronic circuit 1210 may control the memory management unit 1420 based on a high-level Application Programming Interface (API) such as the C language.

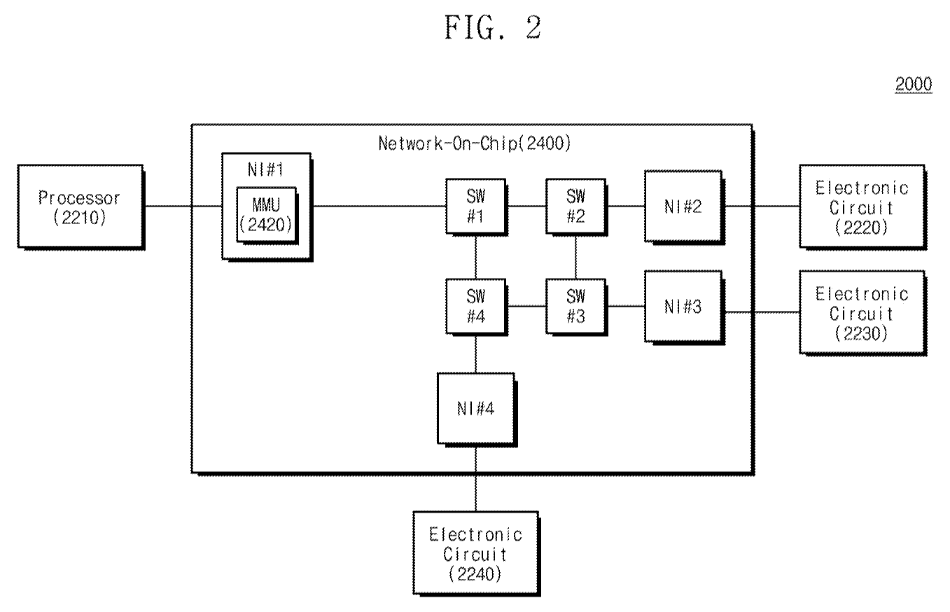

FIG. 2 is a block diagram illustrating an example configuration of computing device of FIG. 1.

The computing device 2000 may include a processor 2210, electronic circuits 2220, 2230, and 2240, and a network-on-chip (NOC) 2400.

The processor 2210 and the electronic circuits 2220, 2230, and 2240 correspond to the electronic circuit 1210 and the electronic circuits 1220, 1230, and 1240 of FIG. 1, respectively, and thus detailed description thereof will be omitted.

The NOC 2400 may include network interfaces NI#l, NI#2, NI#3, and NI#4. The NOC 2400 may provide a communication channel between the electronic circuits 2210, 2220, 2230, and 2240 through the network interfaces NI#1, NI#2, NI#3, and NI#4. The network interface NI#1, the network interface NI#2, the network interface NI#3 and the network interface NI#4 are network interfaces corresponding to the processor 2210, the electronic circuit 2220, the electronic circuit 2230, and the electronic circuit 2240, respectively.

The network interfaces NI#1, NI#2, NI#3, and NI#4 may support the processor 2210 and the electronic circuits 2220, 2230, and 2240 to communicate through the NOC 2400. For example, the network interfaces NI#1, NI#2, NI#3, and NI#4 may convert transactions received from the processor 2210 and the electronic circuits 2220, 2230, and 2240 into a format used in the NOC 2400, and may deliver the format-converted transactions to the NOC 2400. The network interfaces NI#1, NI#2, NI#3, and NI#4 may convert transactions received from the NOC 2400 into a format used in the processor 2210 and the electronic circuits 2220, 2230, and 2240, and may deliver the format-converted transactions to the processor 2210 and the electronic circuits 2220, 2230, and 2240.

For example, the processor 2210 and the electronic circuits 2220, 2230, and 2240 perform an interface operation with the NOC 2400 using one of the protocols Advanced Extensible Interface (AXI), Advanced High-performance Bus (AHB), and Advanced Peripheral Bus (APB), and the network interfaces NI#1, NI#2, NI#3, and NI#4 may perform protocol conversion.

The NOC 2400 may be connected to network interfaces NI#1, NI#2, NI 3_{—} and NI#4 and include switches SW#1, SW#2, SW#3, and SW#4 for controlling the transfer of transactions between network interfaces NI#1, NI#2, NI#3, and NI#4. The switches SW#1, SW#2, SW#3, and SW#4 may be connected to the network interfaces NI#1, NI#2, NI#3, and NI#4, respectively.

The switch SW#k (k is a positive integer between 1 and 4) of the NOC 2400 receives the transaction from the electronic circuit corresponding to the network interface NI#k through the network interface NI#k. The switch SW#k may identify the destination of the received transaction. For example, if the received transaction is to be delivered to the i-th electronics ti is a positive integer between 1 and 4), the destination of the received transaction may be the switch SW#i connected to the i-th circuit or the i-th circuit. When the switch SW#k and the switch SW#i are directly connected, the switch SW#k may directly deliver the received transaction to the switch SW#i. When there are other switches between the switch SW#k and the switch SW#i. The switch SW#k may deliver the received transaction to the switch SW#i through the relay of the other switches.

That is, as the switches SW#1, SW#2, SW#3, and SW#4 are configured in the form of a network, the NOC 2400 may flexibly support communication between the processor 2210 and the electronic circuits 2220, 2230, and 2240. Also, even when the number of electronic circuits connected to the NOC 2400 increases or decreases, the NOC 2400 may have scalability to support seamless communication between electronic circuits by adding electronic circuits to the destination object or removing electronic circuits from the destination object.

Although it is shown in FIG. 2 that the number of the switches SW#1, SW#2, SW#3 and SW#4 may be described to be equal to the number of the processors 2210 and the electronic circuits 2220, 2230 and 2240. The number of switches may not necessarily correspond to the number of processors 2210 and electronic circuits 2220, 2230, and 2240. For example, the number of switches connected between the processor 2210 and the electronic circuits 2220, 2230, and 2240 may be fewer than the number of the processor 2210 and the electronic circuits 2220, 2230, and 2240. However, in such a case, the number of workloads to be performed by the switches may increase and the design complexity may increase.

The network interface NI#1 connected to the processor 2210 may include a memory management unit 2420. The network interface NI#1 may convert transactions received from the processor 2210 into a format used in the NOC 2400, and may deliver the format-converted transaction to the NOC 2400. In addition, the network interface NI#1 may convert transactions received from the NOC 2400 into a format used in the processor 2210, and may deliver the format-converted transaction to the processor 2210.

In relation to the computing device 2000, the network interface NI#1 connected to the processor 2210 may provide the functionality of the memory management unit 2420 to the processor 2210 by including the memory management unit 2420. For example, when the electronic circuit 2220 is SRAM, the memory management unit 2420 enables the processor 2210 to access the electronic circuit 2220 using a virtual memory address, thereby maximizing memory efficiency.

According, to one embodiment of the present disclosure, the processor 2210 may deliver a transaction for controlling the memory management unit 2420 to the network interface NI#1. For example, the processor 2210 may transmit to the network interface NI#1 a control command for differently configuring the memory management unit 2420 according to an application program to be executed. When receiving a control command for controlling the memory management unit 2420, the network interface NI#1 may omit the operation of converting the format of the received control command into the format used in the NOC 2400. This is because the control command is only used in the memory management unit 2420 itself and need not be delivered to other electronic circuits 2220, 2230, and 2240.

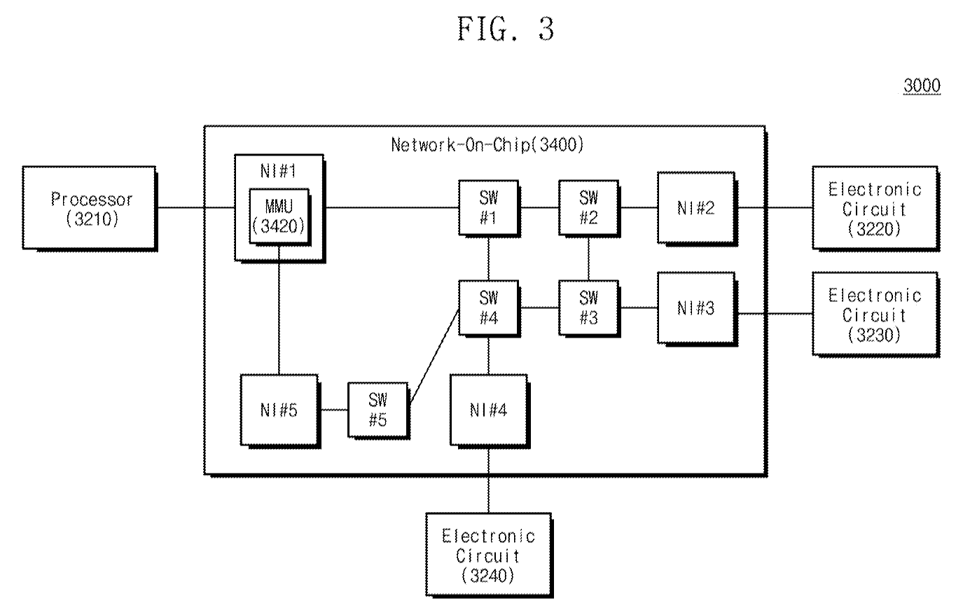

FIG. 3 is a block diagram illustrating an example configuration of computing device of FIG. 1.

Comparing the computing device 3000 of FIG. 3 with the computing device 2000 of FIG. 2, the NOC 3400 further includes an additional network interface NI#5 connected to a memory management unit 3420. For example, if the memory management unit 3420 is not designed based on a protocol inside the NOC 3400 and is designed based on a general protocol such as AXI, AHB, or APB protocol, the network interface NI#5 may be added.

The network interface NI#5 may convert transactions received from the memory management unit 3420 into a format used in the NOC 3400, and may deliver the format-converted transaction to the NOC 3400. In addition, the network interface NI#5 may convert transactions received from the NOC 3400 into a format used in the memory management unit 3420, and may deliver the format-converted transaction to the memory management unit 3420. The switch SW#5, according to one embodiment of the present disclosure, may receive a transaction from the memory management unit 3420 through the network interface NI#5.

In other words, like the processor 3210 and the electronic circuits 3220, 3230 and 3240, the computing device 3000 may include the memory management unit 3420 in the existing network by treating the memory management unit 3420 as an independent electronic circuit connected to the NOC 3400.

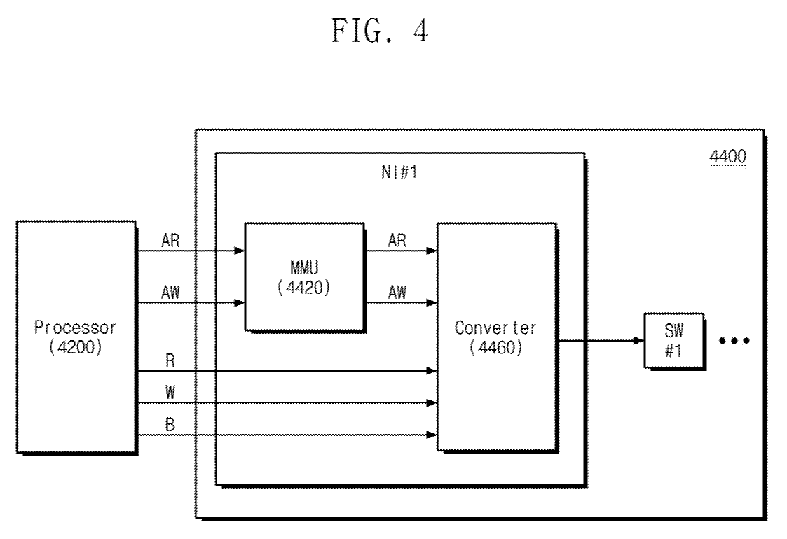

FIG. 4 is a block diagram illustrating an example configuration of computing device of FIG. 1.

The processor 4200, the NOC 4400 and the network interface NI#1 may correspond to the processor 3210, the NOC 3400, and the network interface NI#1, respectively, of FIG. 3. In the NOC 4400, components other than the network interface NI#1 and the switch SW#1 are omitted.

The processor 4200 may perform an interface operation with the NOC 4400 using a plurality of channels separated from each other. In this embodiment, a channel for delivering, address information among the plurality of channels may be connected to the memory management unit 4420.

According to one embodiment of the present disclosure, the processor 4200 may perform an interface operation with the NOC 4400 based on the AXI protocol. The AXI protocol is a scheme for performing the interface operation through the address read channel AR, the address write channel AW, the data read channel R, the data write channel W, and the write response channel B.

The converter 4460 may convert the transaction based on the AXI protocol into a format based on the protocol used in the NOC 4400, and deliver the format-converted transaction to the switch SW#1.

An address read channel AR and an address write channel AW for transmitting address information may be connected to the memory management unit 4420. The address read channel AR and the address write channel AW may be connected to the converter 4460 through the memory management unit 4420. The memory management unit 4420 may obtain the actual memory address based on the virtual memory address received through the address read channel AR or the address write channel AW. The actual memory address may be delivered to the converter 4460 and the converter 4460 may output the transaction including the actual memory address information. The outputted transaction may be delivered to other electronic circuits connected to the NOC 4400 through the switch SW#1.

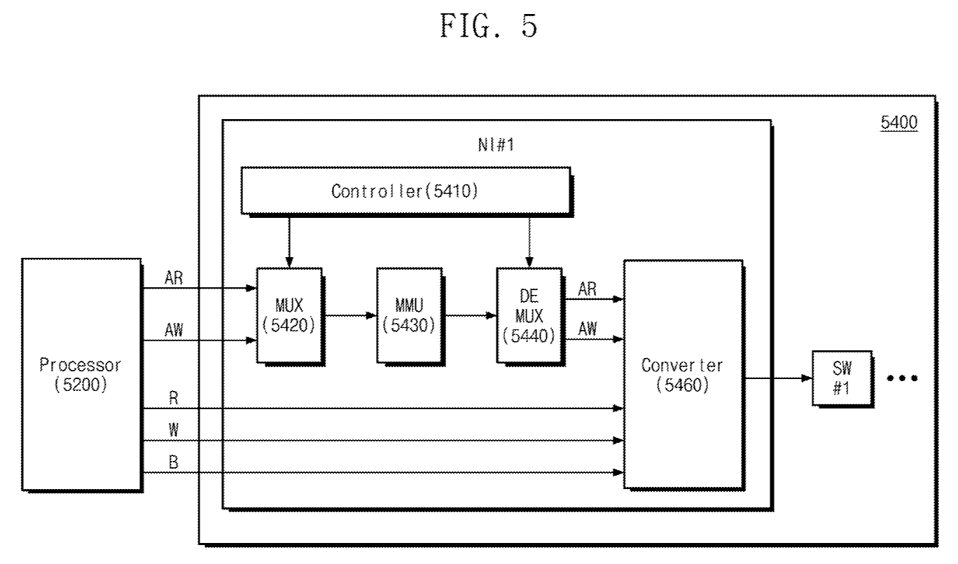

FIG. 5 is a block diagram illustrating an example configuration of computing device of FIG. 1.

The processor 5200, the NOC 5400, the memory management unit 5430, and the converter 5460 may correspond to the processor 4200, the NOC 4400, the memory management unit 4420, and the converter 4460, respectively. For convenience of explanation, in the NOC 5400, components other than the network interface NI#1 and the switch SW#1 are omitted.

The network interface NI#1 may include a controller 5410, a multiplexer (MUX) 5420, a memory management unit 5430, an inverse multiplexer (DEMUX) 5440, and a converter 5460.

The MUX 5420 and the DEMUR 5440 may be used so that the address read channel AR and the address write channel AW share one memory management unit 5430. The MUX 5420 and the DEMUX 5440 may be controlled by the controller 5410.

The controller 5410 according to an embodiment may control the MUX 5420 and the DEMUX 5440 to allow the memory management unit 5430 to preferentially processes one of the request (e.g., command) received from the address read channel AR and the request (e.g., command) received from the address write channel AW. For example, the MUX 5420 may preferentially select one of the request received from the address read channel AR and the request received from the address write channel AW, and may deliver the selected request to the memory management unit 5430.

The processor 5200 may deliver the first request to the MUX 5420 through the address read channel AR with a valid signal indicating that the first request is valid. In addition, the processor 5200 may deliver the second request to the MUX 5420 through the address read channel AR with a valid signal indicating that the second request is valid. The MUX 5420 may transmit a response signal (e.g., ready signal to the processor 5200 for the selected one request, in response to the received first request and second request. That is, process of a request corresponding to a ready signal not being transmitted may be delayed.

The DEMUR 5440 may receive the request outputted from the memory management unit 5430, and deliver the request to the converter 5460 through a selected one of the address read channel AR and the address write channel AW outputted from the DEMUR 5440. The request outputted by converter 5460 may be delivered to other electronic circuits connected to the NOC 5400 through the switch SW#1.

The disclosed computing device may provide the functionality of a memory management unit to a small or lightweight processor that does not include a memory management unit by including a memory management unit in the NOC. Thus, a small or lightweight processor may efficiently use the memory.

Although the exemplary embodiments of the inventive concept have been described, it is understood that the inventive concept should not be limited to these exemplary embodiments but various changes and modifications may be made by one ordinary skilled in the art within the spirit and scope of the inventive concept as hereinafter claimed.

What is claimed is:

1. A computing device comprising:
electronic circuits; and
network-on-chip configured to provide a communication channel between the electronic circuits,
wherein one of the electronic circuits is a processor,
wherein the network-on-chip comprises a memory management unit for supporting a use of a virtual memory address of the processor.

2. The computing device of claim 1, wherein each of the electronic circuits comprises at least one of a Universal Asynchronous Receiver Transmitter (UART) interface, a random access memory (RAM), a read only memory (ROM), or a serial programming interface (SPI).

3. The computing device of claim 1, wherein the network-on-chip further comprises:
network interfaces configured to convert a type of transactions received from each of the electronic circuits; and
a switch configured to control transmission of the transaction between the network interfaces.

4. The computing device of claim 3, wherein among the network interfaces, a network interface corresponding to the processor comprises the memory management unit.

5. The computing device of claim 4, wherein the network-on-chip comprises an additional network interface corresponding to the memory management unit.

6. The computing device of claim 4, wherein the processor performs an environmental configuration for the memory management unit by delivering a control command to the additional network interface corresponding to the processor.

7. The computing device of claim 4, wherein each of the electronic circuits uses one of Advanced Extensible Interface (AXI) protocol, Advanced High-performance Bus (AHB) protocol, and Advanced Peripheral Bus (APB) protocol to perform an interface operation with the network-on-chip.

8. The computing device of claim 7, wherein when the processor performs an interface operation with the network-on-chip using the AXI protocol, an address read channel and an address write channel are connected between the processor and the memory management unit.

9. The computing, device of claim 8, further comprising a controller,
wherein the controller controls the memory management unit to preferentially process one request selected from among a first request received from the processor through the address read channel, and a second request received from the processor the address write channel.

10. A network-on-chip comprising:
network interfaces configured to convert a type of transactions received from each of the processor and the electronic circuits and
a switch configured to control transmission of the transactions between the network interfaces,
wherein among the network interfaces, a network interface corresponding to the processor comprises a memory management unit.

11. The network-on-chip of claim 10, wherein when the processor performs an interface operation using AXI protocol, an address read channel and an address write channel are connected between the processor and the memory management unit.

12. The network-on-chip of claim 11, wherein the network interface corresponding to the processor further comprises a controller which controls the memory management unit to preferentially process one request selected from among a first request received from the processor through the address read channel, and a second request received from the processor the address write channel.
